(19) United States
(12) Patent Application Publication
(10) Pub. No.: US 2016/0004102 A1
(43) Pub. Date: Jan. 7, 2016

(54) Adjustable Lens and Article of Eyewear

(71) Applicant: ADLENS LIMITED, Oxford Oxfordshire (GB)

(72) Inventors: Jon Nisper, Oxford (GB); Robert Edward Stevens, Oxford (GB)

(21) Appl. No.: 14/767,881

(22) PCT Filed: May 24, 2013
(86) PCT No.: PCT/EP2013/060810

§ 371 Date: Aug. 13, 2015

(30) Foreign Application Priority Data
Feb. 15, 2013 (GB) 1302717.2
Feb. 15, 2013 (GB) 1302723.0

(51) Int. Cl. G02C 11/00; G02B 27/01; G02C 7/08; G02B 27/42; G02B 5/18; G02B 3/14

(52) U.S. Cl. CPC G02C 11/10; G02B 5/1814; G02B 3/14; G02C 7/085; G02B 27/4205; G02B 27/0172; G02B 2027/0174; G02B 2027/0178; G02C 2202/20

(57) ABSTRACT

An adjustable fluid-filled lens having a rear surface, a front surface, and a body of fluid between the front and rear surfaces. The lens incorporates a diffractive pattern within the fluid.

The present invention relates to an adjustable, fluid-filled lens and in particular a lens incorporating a diffractive pattern, and an article of eyewear comprising such a lens.

Fluid filled lenses of the kind in which the pressure of fluid is used to control the shape of an elastic membrane in contact with the fluid are known in the art. Generally these lenses may be of the “fluid injection” type, in which the amount of fluid is controlled within an envelope that is bouhded on one side by the membrane, or the “fluid compression” type in which the volume of an envelope is adjusted that is bounded on one side by the membrane and contains a fixed amount of fluid. In each case, the pressure of the fluid within the envelope is adjusted, either by adding or removing fluid to or from the envelope, or by changing the volume of the envelope, to control the fluid pressure acting on the membrane, thereby to control the shape of the membrane.

Whilst various applications of adjustable lenses are possible, for example in cameras and other optical equipment, one use is in eyewear. An adjustable lens is particularly useful for correction of presbyopia—a condition in which the eye exhibits a progressively diminished ability to focus on close objects with age. If the wearer additionally suffers from myopia—a condition in which the eye does not focus objects viewed at distance correctly (nearsightedness or shortsightedness)—the adjustable lens can be used in combination with a negative corrective lens to account for the myopia. An adjustable lens is advantageous because the wearer can obtain correct vision through a range of distances from long-distance to near vision. The lens is typically designed such that it can be adjusted when required for close tasks and the object may be brought into focus in the same region of the lens through which distant objects are viewed. This is more ergonomic than bifocal lenses in which near-vision correction is provided in a bottom region of the lens, thereby only allowing the user to see close objects in focus when looking downwardly.

A helmet mounted display (HMD) is an item of headwear which incorporates a display to project an image into the wearer's eye. The display may be transparent, thereby allowing the wearer to view the image whilst still being able to see his field of view. In this case the image may be projected across a part of or the whole field of view. Alternatively, the display may be configured to project the image into one eye, such that the wearer's field of view can be observed through the other eye. The projected image is generated by a projector and is usually received as data and processed into an image by the projector. The data often relates to the wearer's environment, for example a fighter pilot might use an HMD to view information such as airspeed, altitude or target range, whilst still being able to see around him to fly the plane. The image is typically generated by a cathode ray tube (CRT) imager or a micro display such as a liquid crystal display (LCD) with a light emitting diode (LED) illuminator.

A disadvantage of the type of HMD described above is that if the wearer needs any sort of vision correction, he would need to wear either eyeglasses or contact lenses in addition to the HMD. This would be inconvenient from a comfort point of view and also when changing focus from far objects to near objects, since the image projected from the display would likely be in a non-optimal location in one or both situations.

It would be desirable to provide an adjustable lens incorporating a display for viewing a projected image in addition to the field of view. It would further be desirable to provide an article of eyewear, such as an HMD, which mitigates the above-discussed problems.

According to a first aspect of the invention, there is provided an adjustable fluid-filled lens having a rear surface; and a front surface and a body of fluid therebetween, the lens incorporating a diffractive pattern within the fluid.

The diffractive pattern may be disposed either at an interface between the lens and the fluid or be supported in the fluid spaced apart from the front and rear surfaces.

The front surface of the adjustable lens preferably comprises an elastic or viscoelastic membrane held around its edge by a supporting member, the membrane being spaced apart from the rear surface. The pressure of the fluid may be adjustable for adjusting the shape of the membrane to thereby vary the power of the lens to focus the first image.

Advantageously the lens may be operable to focus a first image of an object viewed through the lens in a first region of the lens and the optical element may be operable to focus a second image projected onto the diffractive pattern in an overlapping region of the lens. Advantageously, the lens may have an optical centre which remains in a substantially constant position during a range of adjustment of the lens to focus the first image.

In some embodiments, the rear surface is defined by a rear cover on which the diffractive pattern is disposed.

In some embodiments the supporting member and the rear cover are flexibly joined together around their edges to form a sealed envelope in which the fluid is contained. The lens may comprise an envelope in which the fluid is contained, one wall of the envelope defining said front surface. The rear face may be defined by another wall of the envelope, the wall being fixedly attached to the rear cover. The diffractive pattern may be disposed within the envelope.

Preferably the fluid and the diffractive pattern are index-matched.

In some embodiments, the second image may be received through the rear surface of the lens. The second image may be received at an angle of between 10 and 90° to the rear surface.

In other embodiments, the second image may be received through a side of the lens, substantially parallel to the rear surface.

The lens may be thought of as having an axis passing through the front and rear surfaces and as having a width across the lens between first and second sides. The diffractive pattern may be arranged: substantially perpendicular to the axis; at an acute angle to the axis; across a side region of the lens; across a central region of the lens; or across substantially the entire width of the lens, depending on the application or on preference.

The diffractive pattern may comprise one or more of: a diffractive element, a diffractive grating, a bulk holographic element. It could optionally be an exit pupil expander; an functions may be used in combination. In some embodiments the diffractive pattern may be applied to a surface within the fluid in the form of a film, etched onto the surface or as a surface relief.

According to a second aspect of the invention, there is provided an article of eyewear comprising a lens as described above.

The article of eyewear may further comprise or carry an image generating device, arranged to project a second image onto the diffractive pattern. The image generating device may comprise a micro LCD display or an OLED display. The OLED display may be monochromatic or polychromatic. The article of eyewear may further comprise or carry a camera configured to record images, for example images of a wearer's eye. The camera may be incorporated in or carried on the image generating device.

The article of eyewear in some embodiments comprises a frame for holding the lens and a temple attached to or formed as part of the frame. The image generating device and/or the camera may be carried on the frame or the temple. The image generating device and/or the camera may be disposed on one or more of: a bridge of the frame; in a region where the frame and the temple are joined for projecting the second image substantially parallel to the rear face of the lens; and in a region of the temple for projecting the second image at an angle of between 10 and 90° to the rear face.

Embodiments of the invention will now be described, by way of example only, with reference to the accompanying drawings in which:

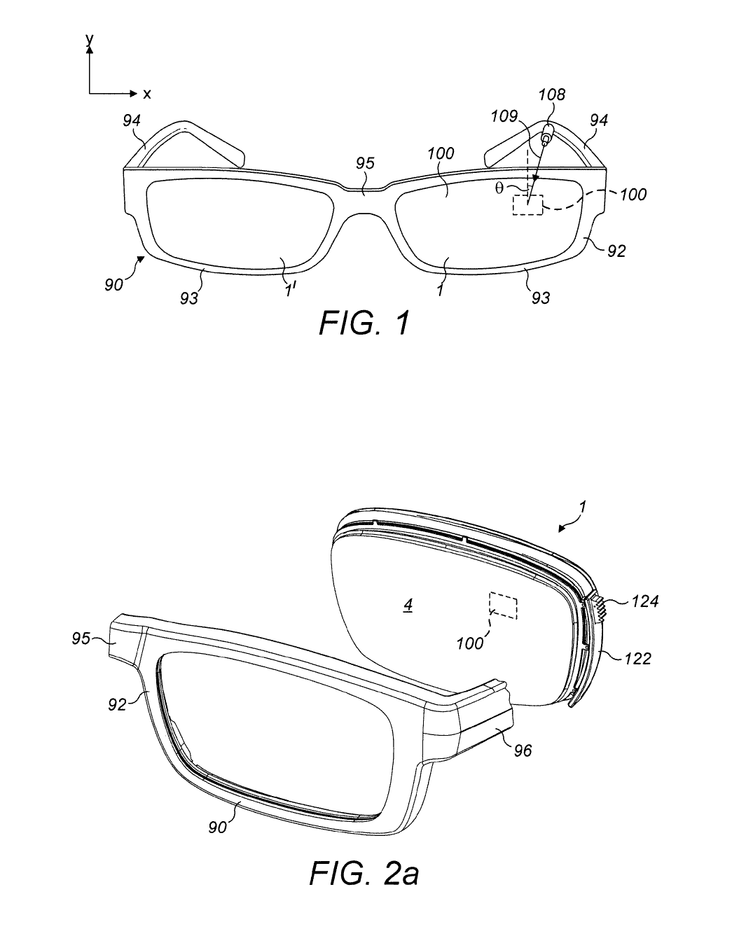

FIG. 1 is a perspective view from above of the front of a pair of eyeglasses comprising a frame that is fitted with two fluid-filled lens assemblies in accordance with a first embodiment of the present invention;

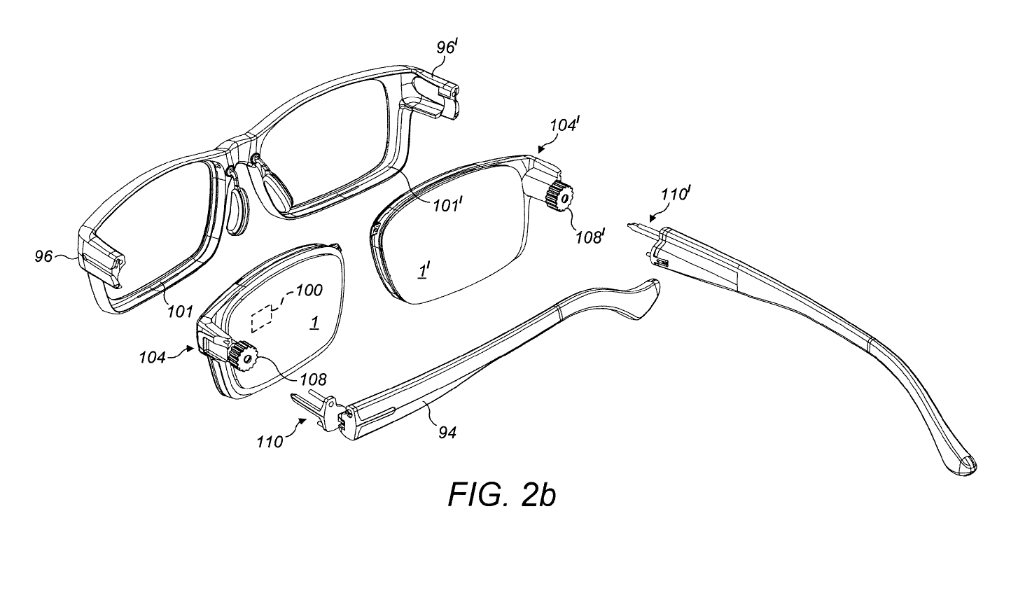

FIG. 2a is a perspective view from above and to the left of the left-hand side of the eyeglasses of FIG. 1 showing how one of the lens assemblies of the first embodiment is fitted to the frame;

FIG. 2b is a perspective view from above and to the reverse side of the eyeglasses of FIG. 1 (i.e. from the wearer's side), also showing how the lens assembly is fitted to the frame;

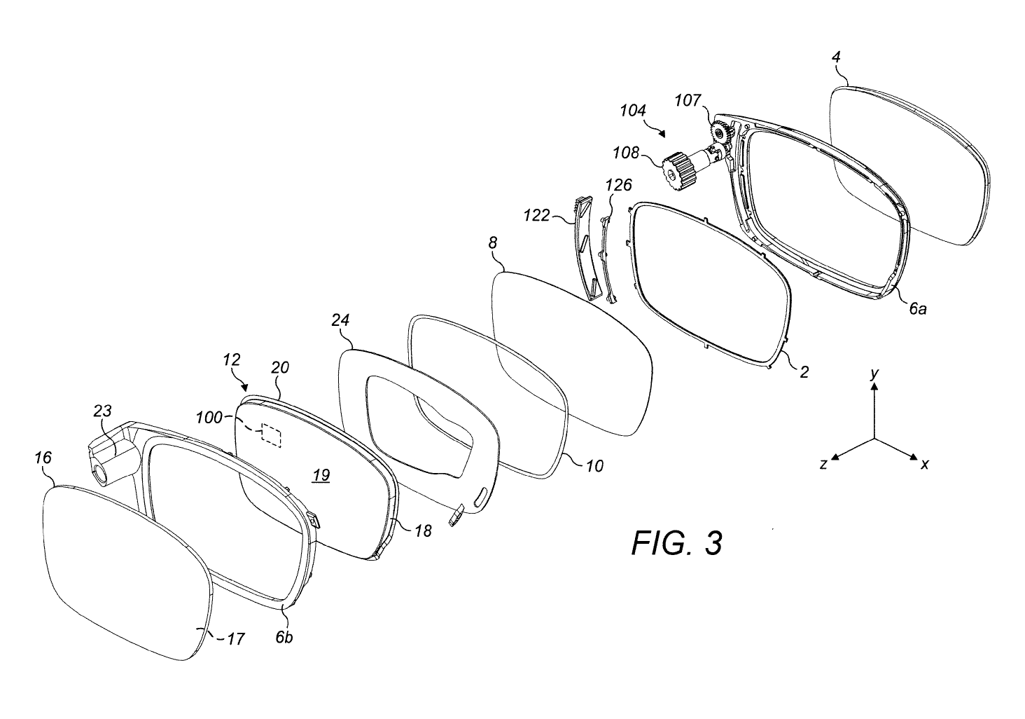

FIG. 3 is an exploded view of the one lens assembly of the first embodiment, showing the parts of the assembly;

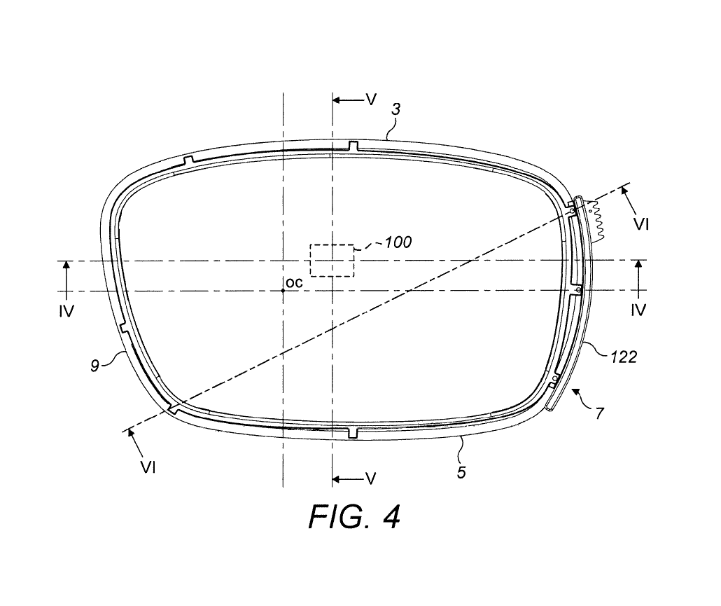

FIG. 4 is a front elevation of the one lens assembly of FIG. 2 prior to adjustment;

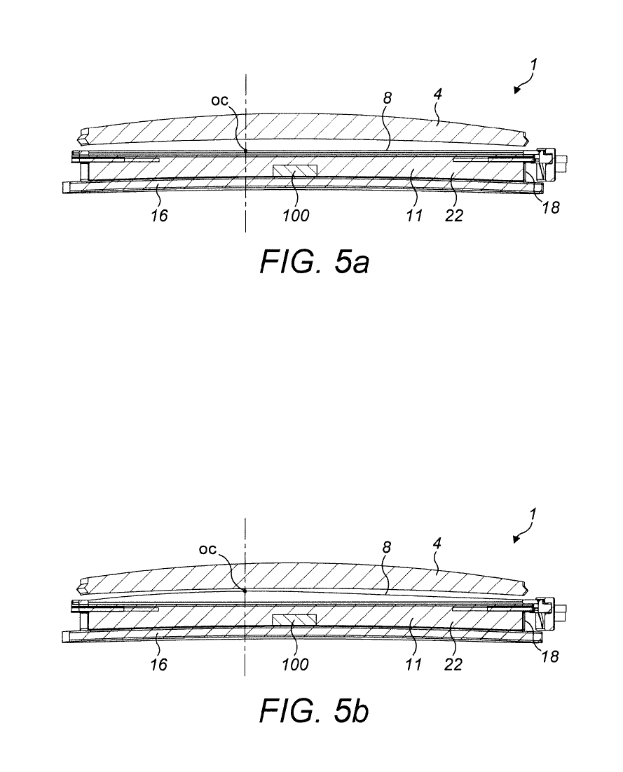

FIG. 5a shows a cross-section of the one lens assembly along the line IV-IV of FIG. 4 and FIG. 5b is a corresponding illustration when the lens assembly has been adjusted;

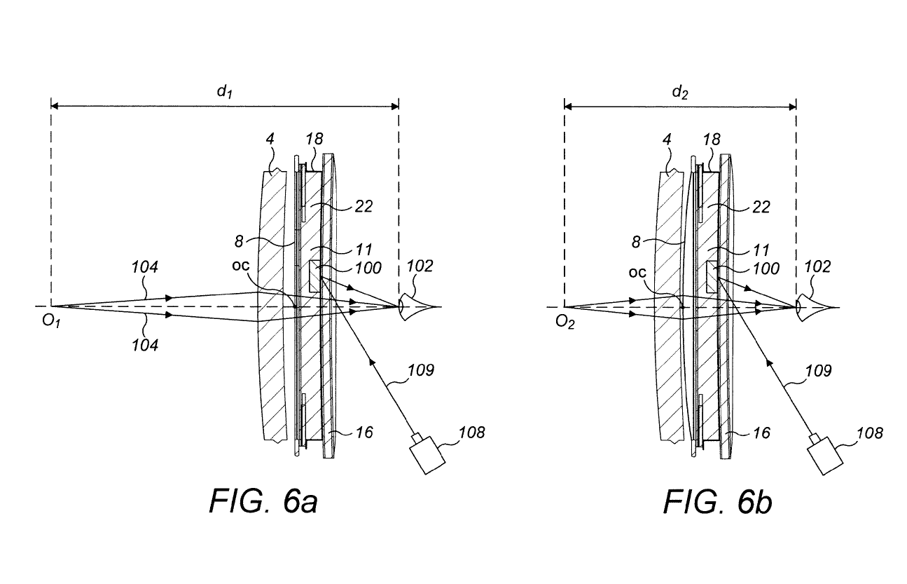

FIG. 6a shows a cross-section of the one lens assembly along the line V-V of FIG. 4, illustrating projection of an image in accordance with the invention and FIG. 6b is a corresponding illustration when the lens assembly has been adjusted;

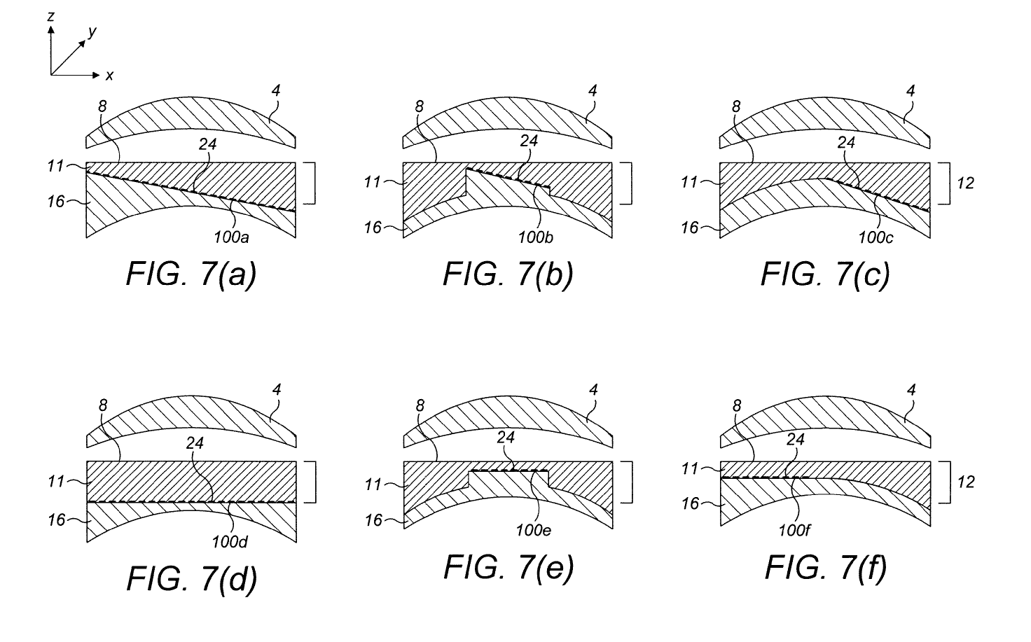

FIGS. 7a-f show schematically a number of alternative configurations of an adjustable lens assembly incorporating an optical element;

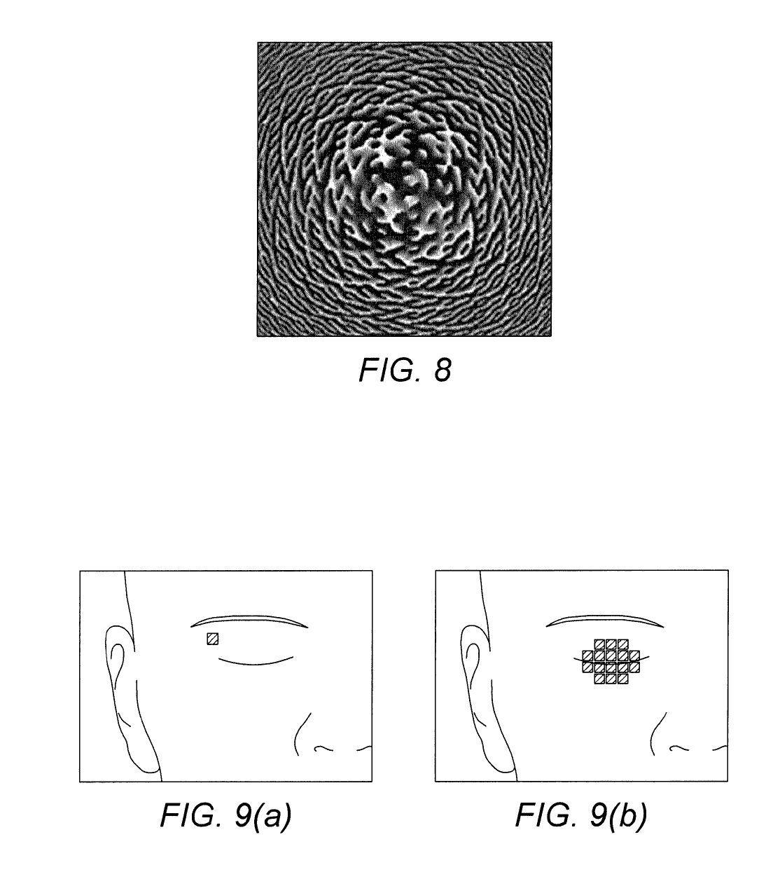

FIG. 8 shows an example of a computer-generated bulk hologram that may be used in an optical element incorporated in an adjustable lens assembly in accordance with the invention; and

FIG. 9a shows an example of an eyebox and FIG. 9b shows an example of an eyebox when a bulk hologram of the type shown in FIG. 7 has been used in an optical element incorporated in an adjustable lens in accordance with the invention.

In the drawings, like reference numerals indicate like parts.

As shown in FIG. 1, a pair of eyeglasses 90 (UK: spectacles) comprises a frame 92 having two rim portions 93 and two temples 94. The rim portions 93 are joined by a bridge 95, and each rim portion 93 is shaped and dimensioned to carry a respective lens assembly 1, 1′ in accordance with an embodiment of the present invention. One of the lens assemblies 1 is used for the left-hand side of the eyeglasses, and the other 1′ is used for the right-hand side. As illustrated in FIG. 2b, the rim portion 93 is formed in its rear side with a recess 101 that accommodates the respective lens assembly 1, 1′. The respective lens assemblies 1, 1′ are snap-fitted into their respective recesses 101,101′.

As can be seen from FIGS. 1 and 2b, the right-hand and left-hand lens assemblies 1, 1′ are mirror images of each another, their construction being otherwise identical. Only the left-hand lens assembly 1 is described in detail below, but it will be appreciated that the construction and operation of the right-hand side assembly 1′ is substantially the same.

As shown in FIGS. 2a and 2b, the frame 93 comprises truncated temples 96, 96′. The lens assemblies 1, 1′ can be held in place in the eyeglasses 90 after snap-fitting into the respective recesses 101, 101′ by means of a screw and locator arrangement 110, 110′ carried on the respective temples 94, 94′. Thus the lens assemblies 1, 1′ are held in the rim portions 93, 93′ respectively at one side by being sandwiched between the truncated temples 96, 96′ and the temples 94.

At the one side held between the truncated temples 96, 96′ and the temples 94, 94′, it can be seen from FIG. 2b that the lens assembly comprises an adjuster 104, 104′ which includes an adjuster wheel 108, 108′. The respective wheel 108, 108′ can be manually turned to operate the respective adjustable lens assembly 101, 101′ to thereby adjust the focal power of the lens 1, 1′, as explained in more detail below.

As illustrated in FIG. 3, the lens assembly 1 comprises a transparent front cover plate 4, a transparent rear cover plate 16 and a two-part housing in the form of a retaining ring 6a,6b, which serves to hold the parts of the lens assembly 1 together, with the front and rear cover plates 4, 16 being spaced apart on the front-rear axis—the z axis as shown in FIG. 3. The retaining ring 6 comprises a front shell 6a and a rear shell 6b.

The front cover plate 4 may be of glass or a suitable transparent polymeric material. In the lens assembly 1 of the present embodiment, the front cover plate is about 1.5 mm thick, but this may be varied. In some embodiments, the front cover plate 4 may comprise a lens of fixed focal power(s), for example a single vision (single power), multi-focal (two or more powers), progressive (graded power) or even an adjustable element. As shown in FIG. 4, for example, in the present embodiment, the front cover plate 4 is plano-convex.

The rear cover plate 16 may be made of glass or transparent polymer. In the present embodiment, the rear cover plate 16 is about 1.5 mm thick, but this may be varied as desired. As with the front cover plate 4, in some embodiments, the rear cover plate 16 may form a lens of a fixed focal power. In the present embodiment, for example, the rear cover plate 16 is a meniscus lens, as best seen in FIG. 4.

To assemble the lens assembly 1, the front shell 6a and the rear shell 6b are pushed together, with other components of the lens assembly 1 (these components do not include the front cover plate 4 and the rear cover plate 6) between them. The rear shell 6b is dimensioned to fit contiguously against the front shell 6a. The front 6a and rear 6b shells can be fitted together whilst allowing room for the other components of the lens assembly 1 to be sandwiched between them. The two may be glued together.

As noted above, the rear cover plate 16 is shown in FIG. 3 as being outside the rear shell 6b, and the front cover plate 4 is shown outside the front shell 6a. The front shell 6a, and the front cover plate 4 have corresponding bevels to facilitate secure fitting of the front cover plate 4 between the front shell 6a and the recess 101 of the rim 93 of the eyeglasses 90.

As best seen in FIG. 2b, the retaining ring 6a,6b is shaped and dimensioned to be received snugly within the frame 93, so that when the lens assembly 1 is held as described above with reference to FIG. 2b, it is held stably without movement. The retaining ring 6 thus forms a stable fixed support.

The other components of the lens assembly 1 mentioned above are the moveable components and are described in the following.

Adjacent the rear retaining ring 6b is a dish-shaped part 12 having a flexible side wall 18 with a forward sealing flange 20 and a rear wall 19. In the present embodiment, the dish-shaped part 12 is made of transparent DuPont® boPET (biaxially-oriented polyethylene terephthalate) and is about 6μ thick, but other suitable materials for the dish-shaped part may be used and the thickness adjusted accordingly. The rear wall 19 of the dish-shaped part 12 is bonded contiguously to the front face 17 of the rear cover plate 16. For this purpose, a transparent pressure-sensitive adhesive (PSA) such, for example, as 3M® 8211 adhesive may be employed. In the present embodiment, a layer of PSA of about 25μ thickness is used, but this may be varied as required for the movable parts of the lens assembly 1.

The side wall 18 of the dish-shaped part 12 is free to move within the retaining ring 6a, 6b, adjacent the rear shell 6b. This floating arrangement allows the dish-shaped part to be compressed in use, and allows other moveable parts of the lens assembly 1 to operate unimpeded by the retaining ring 6a, 6b, as described in more detail below.

The forward sealing flange 20 of the dish-shaped part 12 is bonded to the rear surface of a transparent diaphragm comprising a disk 24. In the present embodiment, as best shown in FIG. 8, the disk 24 comprises a flat plate of polycarbonate having a thickness of about 0.5 mm, but suitable alternative materials that provide the required properties described below may be used instead. In the lens assembly of the present embodiment, the disk 24 is transparent, so as not to be visible to either the wearer of the spectacles 90 or an observer of them.

The front surface of the transparent disk 24 is sealed to a membrane sub-assembly comprising a transparent, non-porous, elastic membrane 8 that is sandwiched between a pair of resiliently bendable membrane supporting rings comprising a front ring 2 and a rear ring 10. The rings 2, 10 are of substantially the same overall geometry as each other and are dimensioned for being received within the retaining ring such that the front ring 2 sits adjacent the front shell 6a of the retaining ring. However, there is a space between the front ring 2 and the front shell 6a so that the rings 2, 10 can change shape or move during use of the lens. The front and rear rings 2, 10 together form a supporting member for the elastic membrane 8. In the present embodiment, the rings 2, 10 are cut from a sheet of stainless steel and the front ring 2 is about 0.3 mm thick, while the rear ring 10 is about 0.05 mm thick. Other materials may be used and the thickness adjusted accordingly to provide the desired stiffness. For example, the front ring 2 may have a thickness in the range 0.2-0.75 mm, suitably 0.3 or 0.4 mm to 0.5 mm. The rear ring 10 may have a thickness in the range 0.01-0.25 mm, suitably 0.025-0.1 mm, e.g. about 0.05 mm

In the present embodiment, the membrane 8 is made of polyethylene terephthalate (e.g. Mylar®) and is about 0.5 mm thick, but alternative materials with a suitable modulus of elasticity may be used as desired. For instance, the membrane 8 may alternatively be made of other polyesters, silicone elastomers (e.g. poly(dimethylsiloxane)), thermoplastic polyurethanes, including cross-linked polyurethanes (e.g. Tuftane®), vinylidene chloride polymers (e.g. Saran®) or glass of suitable thickness.

The front ring 2 comprises a number of tabs 120 around its extent, which protrude outwards from the general shape of the front ring 2 i.e. away from its central enclosed area but in plane with the central enclosed area of the ring 2. Apart from the thickness, the rear ring 10 is shaped and dimensioned similarly to the front ring 2, except it does not have any tabs. These tabs 120 are used as hinge points for hinging the sub-assembly to the retaining ring 6a, 6b at selected discrete locations and for preventing the lens 1 undergoing unwanted out-of-plane bending. In view of the flexibility of the rings, the disk 24 serves as a bending control member to mitigate unwanted in-plane bending.

Referring additionally to FIGS. 5 and 6, the dish-shaped part 12, the membrane 8, the rear supporting ring 10 and the diaphragm 24 define a sealed interior cavity 22, that is filled with a transparent fluid. In the present embodiment, the cavity 22 is filled with transparent oil 11. In the present embodiment, Dow Corning® DC 705 silicone oil (1,3,5-trimethyl-1,1,3,5,5-pentaphenyltrisiloxane having a molecular weight of 546.88) is used, but a variety of other suitable colourless oils are available, especially in the family of high refractive index siloxane oils, for which there are a number of manufacturers. The oil 11 should be chosen so as not be harmful to a wearer's eye in the event of a leakage.

Finally, also visible in FIG. 3 is a cam plate 122 and a cam follower 126. These, together with the adjuster 104 which includes the adjuster wheel 108, are used to adjust the focus of the lens 1 during use.

In operation, the adjuster wheel 108 is rotated, which, via a gear train 107, causes the cam plate 122 to undergo translational movement. The cam follower 126 is fixedly attached to the front ring 2 at three of the tabs 120 on the short side 7 of the lens assembly, and this causes the front and rear rings 2, 10 of the short side 7 to move relative to the rear shell 6b. Thus the volume of the cavity 22 can be selectively reduced or increased and therefore the fluid pressure is respectively increased or decreased. An increase in fluid pressure causes the membrane 8 to distend into a convex shape, thereby increasing the focal power of the lens. Rotation of the adjuster wheel 108 in the opposite direction causes the degree of distension to lessen and hence the focal power of the lens is decreased.

Adjustable lenses of the present embodiment are described in more detail in co-pending international patent applications nos. PCT/EP2012/075549 and PCT/GB2012/051426, the contents of which are incorporated herein by reference.

As best seen in FIG. 4, in the present embodiment, the left-hand lens assembly 1 has a generally rectangular shape with two opposing long sides 3, 5 and two short sides 7, 9 and is shaped and dimensioned to fit in the corresponding recess 101 of the rim portion 93 as described above. The long sides 3, 5 can be considered to define a width of the lens assembly 1 and the short sides 7, 9 can be considered to define a height of the lens assembly 1. It will be appreciated that the shape of the lens assembly shown is only one example of a suitable shape, and the lens assembly according to the invention may be given a wide variety of different shapes. The lens assembly 1 has an optical centre OC, which is the point of greatest distension of the membrane 8 during use. The optical centre OC may not coincide exactly with the geometric centre of the lens assembly 1 because it is preferred for ergonomic or physiological reasons that it be towards the bridge 95.

In the present embodiment, the lens assembly 1 has a zero focal power when it is substantially planar. When operated as described above, the short side 7 of the front and rear rings 2, 10 is selectively moved towards the rear shell 6b of the retaining ring 6a, 6b, thus causing distension of the membrane 8, thereby increasing the focal power of the lens assembly 1 in view of the curvature of the membrane 8. By “prior to adjustment” herein is meant the lens assembly 1 when it is in a substantially planar state. It will be understood that when considering use of the lens by a real wearer this term is somewhat arbitrary as the lens could be in any of a range of possible states and then adjusted or re-adjusted. However, this terminology is used for convenience to explain embodiments of the invention.

FIGS. 6a and 6b as discussed in the following show cross sectional views of the lens assembly 1. In terms of the light paths shown and the relative positions of other items in the figures, these drawings are purely illustrative and are not intended to show to scale the distances between components, or the relative sizes thereof. The light paths and beams are shown schematically as an indication of how embodiments of the invention work. An eye of a wearer of the spectacles 90 is also shown purely as a representation thereof; as the cross-section V-V is not taken on the optical centre OC, the centre of the wearer's eye 102 may in reality be disposed from the view of FIG. 6 in the Y-direction i.e. into the page. It will be appreciated by those skilled in the art that in practice focusing of an image occurs in the lens assembly 1 and this focusing is added to the focusing capability of the wearer's eye to focus an image at his or her retina, resulting in an image as interpreted by the wearer; the terminology used below regarding focusing of an image and “focused image” refer to the additional and supplementary focus afforded by the lens assembly 1 such that an image can then be resolved clearly by the wearer's eye.

Referring now to FIG. 6a, a cross-section of the lens assembly 1 taken on the line V-V in FIG. 4 is shown. The lens assembly 1 is shown relative to the eye 102 of a wearer of the eyeglasses 90, the eye 102 being to the rear of the lens assembly 1, i.e. behind the rear cover 16. The eye as drawn is purely a representation to indicate focusing of an image on the retina. The wearer is observing an object O1 at a first distance d1. Light 104 is transmitted from the object O1 into the lens assembly 1, through the front cover 4. The front cover 4 comprises a lens which focuses a first image of the object O1 at the eye 102. In this figure, the lens assembly 1 is shown prior to adjustment and therefore the lens assembly 1, including the membrane 8, is shown to be substantially planar. In this state, the optical power afforded by the membrane 8 is zero.

A diffractive pattern in the form of an optical element 100 is disposed on the rear cover plate 16. In the present embodiment this is achieved by application of a film to the rear wall 19 of the envelope 12, which itself is glued to the rear cover 16. In practice it is very thin as it is formed as a film, but its size is shown exaggerated for convenience in the drawings. This optical element 100 is shown in FIGS. 1-5 but is shown dotted in FIGS. 1-4 as it is disposed within the sealed interior cavity 22. It is not shown to scale in any of these figures, but these figures merely indicate the approximate position of the optical element 100 relative to the optical centre OC. It is shown in cross section in FIG. 5 but again, its depth as viewed from this angle has been exaggerated. In this embodiment, the optical element 100 is situated leftwards of and slightly above the wearer's eye 102 and extends across only a part of the rear cover plate 16 i.e. over only a partial extent of the width of the lens assembly 1. It also extends only partially within the full height of the lens assembly 1. Thus the optical element 100 is disposed leftwards of and slightly above the optical centre OC of the lens assembly 1 and is small relative to the size of the lens assembly 1. It is also small relative to the region of the lens assembly 1 around the optical centre OC, through which the wearer naturally observes his or her field of view. In the present embodiment the optical element is an exit pupil expander which has been computer-generated as a bulk hologram and etched in photo-resist. This has then been applied to the rear cover plate 16 as a film, to thereby form the optical element 100 on the rear cover plate 16.

A visual representation of the design of the exit pupil expander is shown in FIG. 8 and the improvement it provides over some other optical elements is represented in FIG. 9; it can be seen from FIG. 9b as compared to FIG. 9a that this type of element increases the area in which a projected image can be observed, thereby allowing wearers having different facial dimensions to be able to view the image when wearing eyeglasses sized and shaped to a given set of parameters.

In FIG. 6a is also shown a micro-LCD projector 108. This is disposed at the rear of the lens assembly 1 such that it is able to project a light beam 109 onto the optical element 100. The light beam 109 carries an image generated by the projector 108, referred to hereinafter as the second image. The projector 108 is connected to a device which sends a signal to the projector 108 pertaining to the second image to be projected. The device could be any of a mobile telephone or the like, an RF or Bluetooth® transmitter, a GPS device etc. and the second image may vary with time in accordance with the received signal. The projector 108 is arranged to project the light beam 109 onto the optical element 106 at an angle θ which in the present embodiment is approximately 30° to the perpendicular. This angle is convenient such that the projector 108 can be housed in one of the temples 94. Such a location is advantageous in that it can result in an ergonomic weight balance of the eyeglasses 90. The projector 108 is represented in FIG. 1 on the left-hand temple 94, projecting a light beam 109 at an angle θ onto the optical element 100.

The optical element 100 applies one or more optical effects to the received second image. Optical effects could include focusing, expanding or contracting, diffracting, reflecting or transmitting or any combination thereof. In the case of the exit pupil expander used in this embodiment, the received image is mainly focused, reflected (a small amount, about 2% may pass through the optical element 100) and expanded, as discussed previously with reference to FIG. 9. Thus light from the second image as projected onto the optical element 100 is reflected from the optical element such that the second image can be viewed at the wearer's eye 102.

In view of the position of the optical element 100 within the lens assembly 1, the wearer will view the image projected from the projector 108 as it appears on the optical element 100. Thus the second image will appear to the left of the wearer's eye and slightly higher than where the object O1 is observed via the optical centre OC of the lens assembly 1. It will be understood that the object O1 represents the user's distant field of view and hence that the wearer can observe both the field of view and the second image simultaneously because the second image is superimposed on a part of the first image. Although appearing to the user's left, the second image nevertheless appears sufficiently proximal to the optical centre OC of the lens that a wearer of the eyeglasses 90 can view it comfortably without having to move his or her eyes much, if at all.

Turning now to FIG. 6b, this shows the lens assembly 1 at the same cross-section as FIG. 6a. The wearer's eye 102 and the projector 108 are shown in the same positions as in FIG. 6a. The projector 108 projects the second image onto the optical element 100 such that it can be viewed on the retina of the wearer's eye as described with respect to FIG. 6a. However, in this figure, the lens assembly 1 has been adjusted to increase its optical power. Consequently, the membrane 8 has distended in a convex manner, thus providing a positive increase in optical power. The lens assembly 1 is used in this state to view a second object O2, situated at a distance d2 from the wearer's eye 102, the distance d2 being less than the distance d1 shown in FIG. 6a. Thus the lens assembly 1 is assisting with focussing the first image such that the wearer is able to view the close-up object O2.

Since the optical element 100 is disposed within the fluid 11 but the second image is not projected through the membrane 8, the second image can still be viewed correctly at the wearer's eye 102, even though the optical power of the lens to focus an image incoming from the wearer's field of view through the membrane 8 has changed. Furthermore, because the membrane 8 distends around the OC, the position of the object O2 in the user's field of view is viewed at substantially the same position in the X-Y plane as the object O1 is viewed in the situation shown in FIG. 6a. Consequently, the second image can continue to be viewed by the wearer in the same location in his field of view, even though the object that the wearer observes in his field of view is much closer, accommodate the difference in focal length required to focus on distant and near objects

Another important feature of this embodiment of the invention is that the film carrying the optical element 100 is transparent. The etched surface features as shown in FIG. 9 are also transparent such that the optical element is substantially invisible. Thus the wearer's field of view can be observed through the optical element 100 such that the second image appears in front of the first image, or closer to the user.

Furthermore, the refractive index of the optical element substantially matches the refractive index of the oil 11. Consequently, any light beams representing the first image which pass through the optical element 100 on their path in through the membrane 8 are not refracted any more than they would be if they did not pass through the optical element 100. Thus the first image is not distorted or is only negligibly distorted by the presence of the optical element 100. Additionally, the optical element 100 is substantially invisible to an onlooker observing the wearer's eyeglasses, thus improving the aesthetic appearance of the eyeglasses 90. These effects are achieved because the optical element 100 is disposed next to or within the oil 11.

A further advantage of placing the optical element next to the oil 11, within a sealed unit of the lens is the optical element is protected from damage.

FIG. 7 shows schematically some alternative examples of configurations for the optical element 100 in some embodiments of the invention. All the FIGS. 7a-7f show the optical element 100 disposed in the lens assembly 1. Only some of the parts of the lens assembly 1 are shown, specifically the front cover 4, the rear cover 16, the membrane 8, the envelope 12 and the oil 11. In these embodiments the rear cover 16 comprises a lens, the rear curvature of which can be varied as desired. The figures show the lens assembly 1 schematically in cross-section, in a similar manner to FIG. 5a.

In FIG. 7(a), the optical element 100a is disposed at an angle to the X-Y optical plane of the lens assembly. In other words, the optical element 100a is closer to the rear face of the rear cover 16 at one side of the lens than at the opposite side across the width of the lens assembly 1, thus also passing through the axis of the lens 1 at an angle. This angle is achieved in this embodiment by etching an optical grating onto the rear cover 16. In contrast to the embodiment described above, the optical element 100a extends across substantially the entire width of the lens assembly 1, thereby allowing the second image to be viewed across the entire field of view of the wearer. The angle of the optical element 100a is particularly advantageous in some embodiments of the invention in which the projector 108 is arranged to project the second image in a direction substantially perpendicular to the optical axis of the lens assembly 1. In those embodiments, the projector 108 may be disposed towards the front end of the temple or on the rim 93 of the eyeglasses 90 or in a region where the two are joined. The second image is thereby received through a side of the lens assembly 1. Specifically, it enters at the short side 7 through the flexible side wall 18 of the envelope 12, such that it passes through some of the oil 11 before reaching the optical element 100a.

In the embodiment of FIG. 7a, in view of the relative positions of the components and the direction at which the second image enters the lens assembly 1, the optical element 100a used is a diffractive grating. This allows the incoming image substantially to pass through the optical element 100a, such that it is diffracted.

The optical element 100 thus comprises a diffractive pattern 24. The characteristics of the diffractive pattern 24 will need to be designed so that the light emitted by the projector 108 is diffracted through the angle between the optical element 100a and the wearer's pupil. The skilled person would be well aware how to do this without explicit instruction as he will know that the angle through which light is diffracted by a diffraction grating is given by:

$${θ}_{m} arc sin ( \frac{m λ}{d} - sin {θ}_{i} )$$

where θₘ is the angle of diffraction; m is the order of diffraction; λ is the wavelength of light; d is the spacing between slits (or other diffractive features) in the diffractive pattern; and θᵢ is the angle of incidence of the light from the projector 108. Given this equation, it is a straightforward matter to design a diffractive pattern by selecting a suitable value for d to cause light emitted by the projector 108 to be diffracted suitably so that the light will be diffracted into the user's pupil.

In FIG. 7(b), the optical element 100b is disposed at a similar angle to the embodiment of FIG. 7(a) but it only extends across a central portion of the lens assembly 1. This embodiment is suitable for use with the projector 108 disposed as for the embodiment of FIG. 7(a) but allows the second image to be viewed in a central portion only of the wearer's field of view. A diffractive pattern would form a suitable optical element 100b in this embodiment.

In FIG. 7(c), the optical element 100c is disposed at a similar angle to the embodiments of FIGS. 7(a) and 7(b) but it only extends across a portion at one side of the lens assembly 1. This embodiment is suitable for use with the projector 108 disposed as for the embodiments of FIGS. 7(a) and 7(b) but allows the second image to be viewed to one side of the wearer's field of view. A diffractive pattern would form a suitable optical element 100b in this embodiment.

In FIG. 7(d), the optical element 100d is disposed parallel to the X-Y plane, as in the embodiment described above with reference to FIGS. 1-6. However, in this embodiment, it extends across substantially the entire width of the lens assembly 1, thereby allowing the second image to be viewed across the entire field of view of the wearer.

In FIG. 7(e), the optical element 100e is also disposed parallel to the X-Y plane, as in the embodiment of FIG. 7(d). However, the optical element 100d only extends across a central portion of the lens assembly 1 and therefore it allows the second image to be viewed only in a central portion of the wearer's field of view.

In FIG. 7(f), the optical element 100f is also disposed parallel to the X-Y plane, as in the embodiments of FIGS. 7(d) and 7(e). However, the optical element 100f only extends across a side portion of the lens assembly 1 and therefore it allows the second image to be viewed only to one side of the wearer's field of view.

It will be appreciated that many variations may be made to the described embodiments of the invention. Firstly, the shape of the lens may be different from that of the embodiments shown, but the principles of the invention would still apply. For example, the shapes and sizes of the various elements of the lens assembly 1 could be different. The lens assembly 1 could be a different shape, for example round. It may not be necessary for the supporting member to comprise two rings, nor for it to be bendable, particularly for a round lens. The ring or rings may vary in thickness. The lens assembly may not require a support disk 24. The hinging mechanism provided by the tabs 120 is also not essential. The adjustment mechanism could be different from the cam plate mechanism shown; the adjustment mechanism could be mechanically, electrically or magnetically operated and/or may involve use of a phase change material, e.g. a shape memory alloy (SMA), wax or an electro-active polymer. The invention is equally applicable to fluid-filled lenses in which the pressure of the fluid is adjusted by addition of fluid (the “fluid injection” type). The lens assembly 1 does not have to be dynamically adjustable through all possible degrees of distension but may alternatively be adjustable at discrete lens powers. There may be more than one adjustable membrane and the shape of the front and rear covers or lenses could be different. Other types of fluid could be used than the above-described oil. It is not essential for the optical element 100 to be transparent, nor for it to be index-matched to the fluid, although these are preferred features.

In the above-described embodiments, the fluid is held in an envelope 12. In the above-described embodiments, the envelope 12 is disposed on the rear cover plate 16. This arrangement could be varied. For example, the rear face 19 of the envelope 12 could be omitted and instead, the flexible side walls 18 of the envelope 12 could be joined directly to the rear cover 16. Another alternative is for the envelope 12 additionally to hold the rear cover 16 therein. The optical element could thus be disposed on the rear cover 16 and if that rear cover comprises a lens, it could be etched into the lens. Alternatively it could be placed on the rear face 19 of the envelope 12.

The type of diffractive pattern could be different from the optical element 100 in the described embodiments. Other possibilities are a beam splitter, a thin film stack; a diffractive pattern in the form of other bulk holographic elements; an etched element; a film; and a coating. The optical element does not have to be in direct contact with the rear cover 16, provided it is in contact with the fluid. It could be suspended in the oil 11, supported in the region of its edges such that it does not contact any or all of the surfaces of the envelope 12 or the rear cover 16. Thus it could be at an interface between the front and/or rear covers 4, 16 and the oil or it could be supported in the oil such that it is spaced apart from the front and rear surfaces 4, 16. The optical element could be formed by various means such as etching, molding or grinding or by application of a film.

The arrangements of the various components of the embodiments shown can be varied. For example, the location of the projector 108 can be varied from the examples shown and discussed. The angle of projection of the image could also be different from that shown in the embodiment described with reference to FIGS. 1-6. For example it could be 10-50°, 15-40°, 20-35° or 28-32°. In other embodiments, the angle of projection may be perpendicular to the optical axis but it may vary slightly from the perpendicular, for example in a range of 80-100°, 85-95° or 88-102°. Different types of projector could be used such as a CRT projector. The invention could be implemented in other eyewear such as a head-up display or an HMD. Other embodiments may also include a camera. The cameral may be designed to record images, for example of the wearer's eye.

1. An adjustable fluid-filled lens comprising:
a rear surface;
a front surface; and
a body of fluid therebetween, wherein the lens incorporates a diffractive pattern within the fluid.

2. The adjustable fluid-filled lens as claimed in claim 1, wherein the diffractive pattern is disposed either at an interface between the lens and the fluid or is supported in the fluid spaced apart from the front and rear surfaces.

3. The adjustable fluid-filled lens as claimed in claim 1,
wherein the front surface comprises an elastic or viscoelastic membrane held around its edge by a supporting member, the membrane being spaced apart from the rear surface, and wherein the pressure of the fluid is adjustable for adjusting the shape of the membrane to thereby vary the power of the lens to focus the first image.

4. The adjustable fluid-filled lens as claimed in claim 1, wherein the lens is operable to focus a first image of an object viewed through the lens in a first region of the lens and wherein the diffractive pattern is operable to focus a second image projected onto the diffractive pattern in an overlapping region of the lens.

5. The adjustable fluid-filled lens as claimed in claim 1, wherein the rear surface is defined by a rear cover on which the diffractive pattern is disposed.

6. The adjustable fluid-filled lens as claimed in claim 5, wherein the supporting member and the rear cover are flexibly joined together around their edges to form a sealed envelope in which the fluid is contained.

7. The adjustable fluid-filled lens as claimed in claim 5, further comprising an envelope in which the fluid is contained, one wall of the envelope defining said front surface, wherein the rear face comprises another wall of the envelope, the wall being fixedly attached to the rear cover, and wherein the diffractive pattern is disposed within the envelope.

8. The adjustable fluid-filled lens as claimed in claim 1, wherein the fluid and the diffractive pattern are index-matched.

9. The adjustable fluid-filled lens as claimed in claim 1, for receiving the second image through the rear surface of the lens.

10. The adjustable fluid-filled lens as claimed in claim 9, for receiving the second image at an angle of between 10 and 90° to the rear surface.

11. The adjustable fluid-filled lens as claimed in claim 4, for receiving the second image through a side of the lens, substantially parallel to the rear surface.

12. The adjustable fluid-filled lens as claimed in claim 1, wherein the lens has an axis passing through the front and rear surfaces and a width across the lens between first and second sides, and wherein the diffractive pattern is arranged: substantially perpendicular to the axis; at an acute angle to the axis; across a side region of the lens; across a central region of the lens; or across substantially the entire width of the lens.

13. The adjustable fluid-filled lens as claimed in claim 1, wherein the diffractive pattern comprises one or more of: a diffractive element, a diffractive grating, a bulk holographic element; an optical element; an exit pupil expander; a beam splitter; an etched element; a film; and a coating.

14. An article of eyewear, comprising:
an adjustable fluid-filled lens having a rear surface;
a front surface; and
a body of fluid therebetween, wherein the lens incorporates a diffractive pattern within the fluid.

15. The article of eyewear as claimed in claim 14, further comprising an image generating device, arranged to project a second image onto the optical element and optionally wherein the image generating device comprises a camera.

16. The article of eyewear as claimed in claim 15, wherein the image generating device comprises a micro LCD display or an OLED display

17. The article of eyewear as claimed in claim 15, further comprising a frame for holding the lens and a temple attached to or formed as part of the frame, wherein the image generating device and/or the camera is carried on the frame or the temple.

18. The article of eyewear as claimed in claim 17, wherein the image generating device and/or the camera is disposed on one or more of: a bridge of the frame; in a region where the frame and the temple are joined for projecting the second image substantially parallel to the rear face of the lens; and in a region of the temple for projecting the second image at an angle of between 10 and 90° to the rear face.
